(19) United States
(12) Patent Application Publication
(10) Pub. No.: US 2009/0292601 A1
(43) Pub. Date: Nov. 26, 2009

(54) Profit-Sharing Incentive System For Account Vendors

(76) Inventor: P. Tom Sullivan, Tetonia, ID (US)

Correspondence Address: Rainier Patents, P.S., 505 W. Riverside Ave, Suite 440, Spokane, WA, 99201, US

(21) Appl. No.: 12/123,644

(22) Filed: May 20, 2008

(51) Int. Cl. G06Q 30/00

(52) U.S. Cl. 705/14.17; 705/14.46

(57) ABSTRACT

A profit-sharing incentive system for account vendors is described. In one implementation, systems and methods estimate an up-front profit share incentive to be paid to a merchant for opening a merchant account that enables credit card payments. The up-front profit share is estimated from parameters such as the merchant's transaction volume and a discount rate. At the beginning of each new profit sharing period, the up-front profit share may be renewed. An online system for marketing merchant accounts can advertise and electronically transfer the up-front profit share amount that is customized for the merchant. The merchant can initiate the process online using a system website. A user interface displays numerous parameters and monetary values associated with a given merchant account, including monthly profit flowing to a processing entity and a current commodity value of the merchant account.

### BACKGROUND

Sellers of goods and services (“merchants”) often enhance their business and increase clientele by accepting diverse forms of payment. The ability to accept payment through credit cards, including debit cards, depends on the merchant establishing a relationship with a bank that has a merchant processing relationship with major credit card organizations (e.g., VISA and MASTERCARD). Such a bank may be referred to as a “member bank.” The relationship, in which the merchant can accept credit card payments (to be processed on the backend by the member bank), is known as a “merchant account.”

Merchant accounts can be marketed to merchants either by the member bank itself or by an agent—i.e., a merchant account vendor (“marketing entity”)—that the bank authorizes, typically referred to in financial industries as an Independent Selling Organization—Member Service Provider, i.e., ISO/MSP (“ISO”). Like the member banks, each ISO is also typically registered with major credit card organizations, such as VISA and MASTERCARD. The actual marketing of merchant accounts is guided by regulations, e.g., often promulgated by banks. Sales using credit cards are governed by Article 2 of the Uniform Commercial Code, among others.

Banks often sponsor the ISOs, which specialize in account marketing, in order to reduce risk and free the bank to maintain emphasis on its own banking customers. The bank, however, provides the backend electronic processing and accounting for the merchant accounts that the ISOs enlist. The banks still maintain control over the marketing by promulgating guidelines, e.g., by limiting approval to merchants who have been in business a certain length of time or within a given proximity to the bank.

From the point of view of an ISO, the ISO must be sponsored by a member bank. The sponsorship usually includes verification by the bank that the ISO is stable and reliable. The ISO pays some fees, for example, to register with VISA and MASTERCARD organizations, and performs the marketing according to regulations. The majority of merchant accounts are marketed to participating merchants by an ISO, not directly by a member bank.

Because most merchant accounts come into existence via an ISO, the merchant approval process, including underwriting, for accounts solicited by ISOs is streamlined for many kinds of businesses and products sold to favor the marketing activities of the ISOs. Thus, a merchant account marketed by an ISO often costs the bank less than if the bank marketed and set up the merchant account itself.

Each merchant account has many associated fees to be administered. Some of the fees are fixed and periodic while others are charged per-item. In some cases a fee may be assessed by the merchant account provider, however, most fixed fees are set by the credit card issuing bank. A rate schedule of “interchange fees”, (typically selected by VISA and MASTERCARD), accommodate use of the different kinds of credit cards and the different types of card transactions. Credit card processing options for a merchant can be selected to include Internet, retail, wireless, mail order, financial software interface, and phone order type transactions. Swiping a card through a card reader places the transaction in a different category than when the credit card's number is manually entered via a keypad.

The “discount rate” is made up of fees, network charges, and profit mark-ups that a merchant pays the member bank for processing credit and debit card transactions. Or, from another perspective, the discount rate is the percentage of each transaction that the bank or processing company charges to handle the transaction for the merchant. The discount rate is more encompassing than the interchange fee, which constitutes the largest component of the discount rate. The bank and/or the ISO also cover costs and obtain their profit by the mark-up included in these fees.

Because each merchant pays to have a merchant account for accepting credit cards and because the numerous fees and schedules—tied as they are to a plethora of tier pricing models imposed by the servicing bank, resulting in an almost unlimited array of different fees—the merchant may become confused as to the status of a merchant account and may be unable to pinpoint the actual value of being able to offer customers the ability to pay by credit card. That is, the fee costs and the lack of certainty about the ongoing business value of a particular merchant account provide a disincentive toward marketing merchant accounts to merchants. What is needed is a system that provides a real incentive for initiating a merchant account and provides ongoing visibility of the profitability of each merchant account.

### SUMMARY

A profit-sharing incentive system for account vendors is described. In one implementation, systems and methods estimate an up-front profit share incentive to be paid to a merchant for opening a merchant account that enables credit card payments. The up-front profit share is estimated from parameters such as the merchant's transaction volume and a discount rate. At the beginning of each new profit sharing period, the up-front profit share may be renewed. An online system for marketing merchant accounts can advertise and electronically transfer the up-front profit share amount that is customized for the merchant. The merchant can initiate the process online using a system website. A user interface displays numerous parameters and monetary values associated with a given merchant account, including monthly profit flowing to a processing entity and a current commodity value of the merchant account.

This summary is provided to introduce the subject matter of profit-sharing incentive systems for account vendors, which is further described below in the Detailed Description. This summary is not intended to identify essential features of the claimed subject matter, nor is it intended for use in determining the scope of the claimed subject matter.

### BRIEF DESCRIPTION OF THE DRAWINGS

FIG. 1 is a diagram of an exemplary profit-sharing incentive system for account vendors.

FIG. 2 is a block diagram of an exemplary online profit-sharing incentive system for account vendors.

FIG. 3 is a block diagram of a front end part of an exemplary incentivizing engine.

FIG. 4 is a block diagram of an exemplary incentivizing engine.

FIG. 5 is a diagram of an exemplary user interface of the profit-sharing incentive system for account vendors.

FIG. 6 is a flow diagram of an exemplary method of transferring an up-front profit share incentive for opening a merchant account.

FIG. 7 is a flow diagram of an exemplary method of transferring recurring profit-shares to incentivize maintenance of a merchant account.

FIG. 8 is a flow diagram of an exemplary method of applying an up-front purchase of processing rights to incentivize opening a merchant account.

### DETAILED DESCRIPTION

Overview

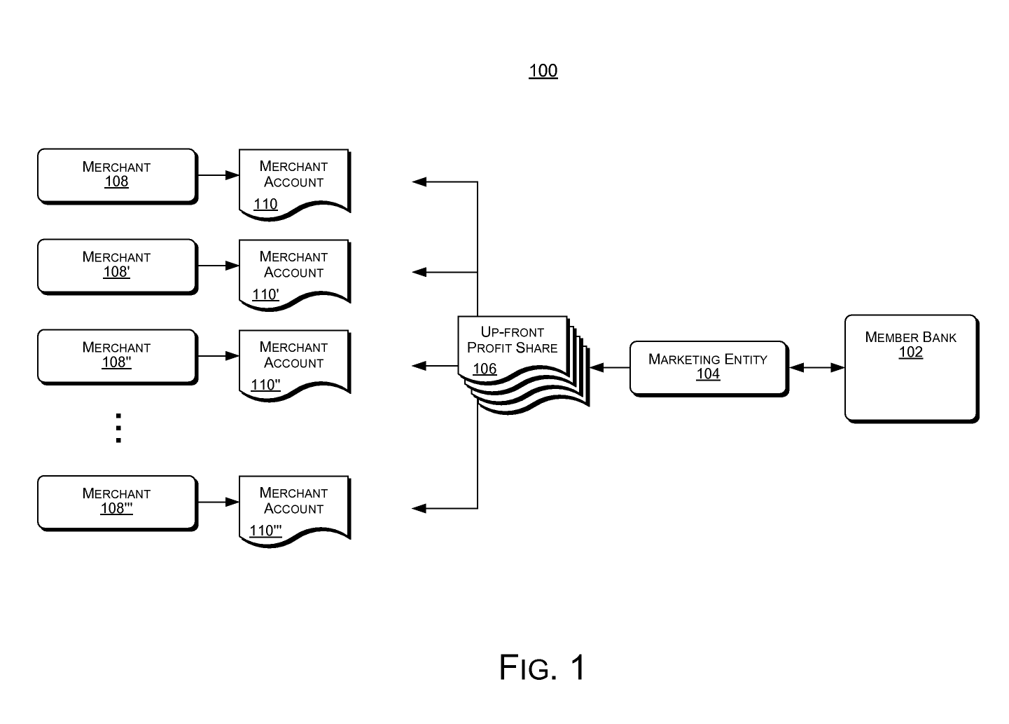

This disclosure describes systems and methods that provide profit sharing incentives for account vendors. In one implementation shown in FIG. 1, an exemplary system 100 or method allows a member bank 102 or associated marketing entity 104 (e.g., an ISO that markets merchant processing) to offer an up-front profit share 106 to prospective merchants 108 as an incentive for forming corresponding merchant accounts 110. A merchant account 110, as described above, is a term of art that describes the relationship between the merchant 108 and the member bank 102 or other processing entity enabling the merchant 108 to accept credit cards and debit cards as a form of payment. “Up-front” as used herein, means that a profit share or purchase amount is transferred to a merchant upon opening a merchant account or near the beginning of a profit sharing period.

The amount of the up-front profit share 106 can be derived from the merchant's past volume, projected into the future, and discounted according to the current interchange fees (discount rate) to find the likely profit that the member bank will earn for processing credit card transactions. For example, the up-front profit share 106 may consist of one-fourth of the discounted profit that would typically be collected from the merchant account 110 by the member bank 102 over four years.

Because the up-front profit share 106 is “up-front”, it provides several potentially important functions. First, the up-front profit share 106 provides an incentive for the merchant 108 to enter into an agreement to open the merchant account 110. Second, because the up-front profit share 106 motivates the merchant 108 to open the merchant account 110, it also provides an incentive on the “back-end” for the sales force of the marketing entity 104 to sell merchant accounts 110.

Third, the derivation of the up-front profit share 106 provides a mechanism for valuing the merchant account itself. Merchant accounts 110 have a market value that can be aggregated across numerous accounts and traded like commodities, similar to mortgages that can be combined into tradable mortgage paper. The merchant account value can be presented to the merchant 108 on a regular basis, e.g., on monthly paper or electronic statements.

Likewise, because the up-front profit share 106 has been calculated “up-front,” a mechanism is in place to show the exact profit flowing to the member bank 102 through the terms of the merchant account contract. This real-time profit can also be presented regularly to the merchant 108 through a computer user interface, or through a periodic statement, thereby avoiding the confusion that typically arises from conventional merchant accounts, in which the merchant 108 has no idea of the merchant account's profitability in view of the numerous complicated pricing tiers and schemas mentioned above.

Fourth, the up-front character of the profit share 106 allows conversion into non-cash incentives, sometime providing even further incentive. For example, the merchant 108 may take the up-front profit share 106 not only as cash or a cash deposit, but also as gift cards, business equipment, purchase credits, etc.

The up-front profit share 106 overcomes the hefty “early termination fee” imposed as an unpleasant disincentive on conventional merchant accounts that close the account before the contract period has run. In the exemplary system 100, the merchant 108 returns merely a pro rata portion of the up-front profit share 106, or if allowed by the member bank 102, may not be required to return anything at all upon early termination.

In one implementation, the merchant is re-profitized at regular intervals. For example, if the up-front profit share 106 is calculated as one-fourth of a discounted four-year profit, then the merchant 108 may be given another profit share 106 every four years.

In a variation, the member bank 102 or the marketing entity 104 executes an up-front purchase of the processing rights of the merchant account 110. For example, the price of the processing rights to service a merchant account 110 for four years may be one-fourth of the discounted profit over the four year period, i.e., twelve times the discounted monthly profit, or some other amount, such as 18 times discounted monthly profit. In some cases, the difference between an up-front profit share 106 and purchasing the processing rights for a time period may be merely semantic or result from variance in the terms selected for a contract. Still, in one implementation, the exemplary system 100 enables an up-front purchase of processing rights associated with the merchant account 110 being opened.

Exemplary Online System

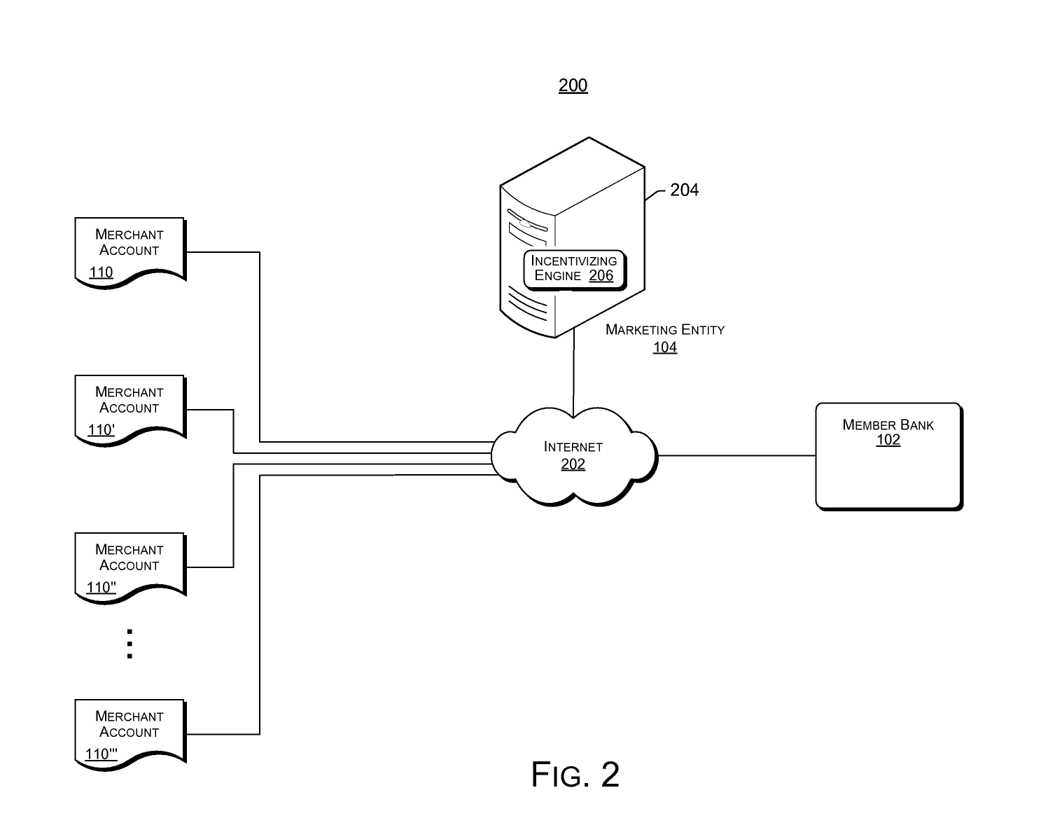

FIG. 2 shows an exemplary online system 200 for providing profit-sharing incentives for opening and in some cases for maintaining merchant accounts 110. In the online system 200, the member bank 102, marketing entity 104, and merchant accounts 110 are communicatively coupled with each other via a network, such as the Internet 202. That is, each entity connects with the Internet 202 using a computing device, such as a desktop computer, notebook computer, mobile computing device, or other computing device that includes a processor, memory, data storage, etc. The communication between the member bank 102, the marketing entity 104, and the merchant accounts 110 is typically conducted over secure communication channels, such as those currently used for financial transactions on the Internet 202.

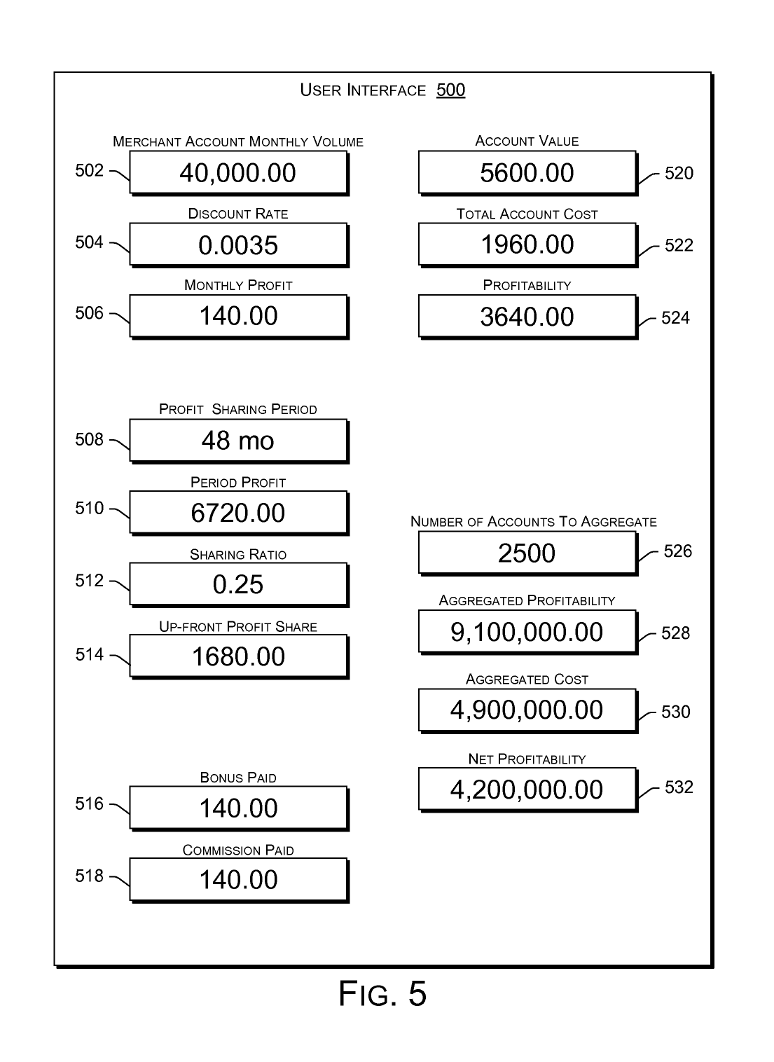

The computing device 204 of the marketing entity 104 hosts an exemplary incentivizing engine 206 that derives the up-front profit share 106 and many other useful data that may be displayed to the merchant 108, marketing entity 104, and/or member bank 102 in statements or on a computerized user interface (e.g., as in FIG. 5). In one implementation, a merchant 108 may initiate opening a merchant account 110 online by accessing a web site of the marketing entity 104 supported by the incentivizing engine 206. Some components of agreement/contract formation to open the merchant account 110, such as underwriting, delivery and installation of card reading terminals, etc., may not be performed online. However, the derivation and transfer of an up-front profit share 106 directly to a merchant 108 opening a merchant account 110 online can be provided in some cases by the online system 200.

Exemplary Engines

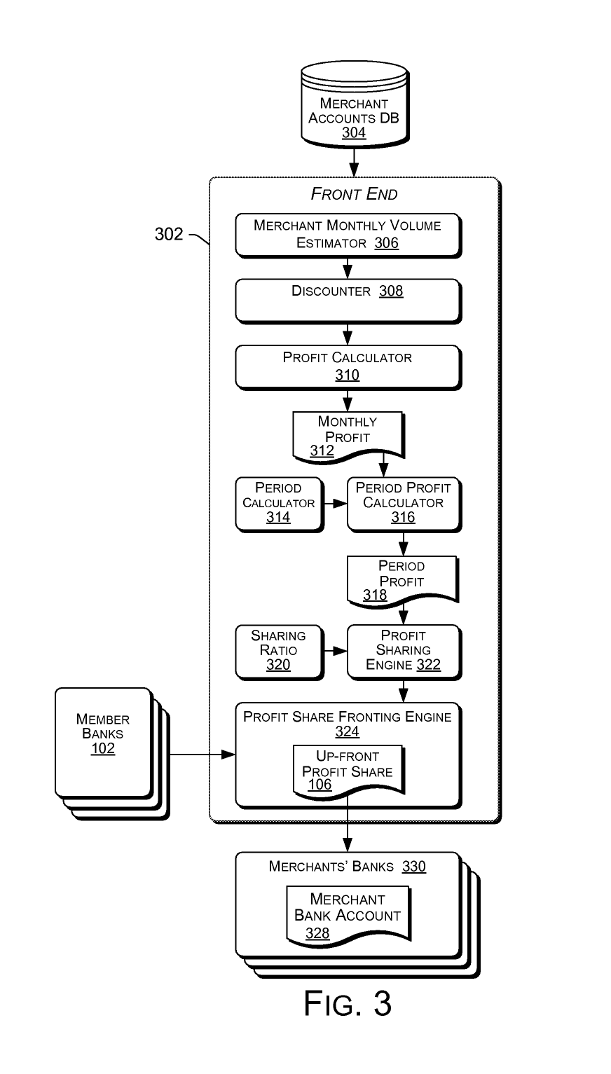

FIG. 3 shows a “front end” part 302 of the exemplary incentivizing engine 206 of FIG. 2. The example configuration illustrated in FIG. 3 is for facilitating description of the profit sharing incentive system 200. Many other arrangements of the components of an exemplary incentivizing engine 206 are possible within the scope of the subject matter. Such an exemplary incentivizing engine 206 can be executed in combinations of hardware, software, firmware, etc.

In FIG. 3, information from numerous merchant accounts 110 may be compiled in a merchant accounts database 304, e.g., that is stored with the marketing entity 104. In the illustrated example, the front end part 302 of the incentivizing engine 206 includes a merchant monthly volume estimator 306, a discounter 308, a profit calculator 310, a monthly profit (buffer) 312, a period calculator 314, a period profit calculator 316, a period profit buffer 318, a sharing ratio engine 320, a profit sharing engine 322, and a profit share fronting engine 324 to deliver the up-front profit share 106. The profit share fronting engine 324 can transfer the profit share 106 from member banks 102 to each merchant bank account 328 in each corresponding merchant's bank 330.

The merchant monthly volume estimator 306 determines the monthly (or other time period) credit card transactions for a given merchant in a monetary quantity, such as U.S. dollars. The discounter 308 applies and in some cases dynamically tracks the current or contracted discount rate (e.g., 0.0035%). The profit calculator 310 applies the discount rate to the monthly volume to determine the monthly profit 312, that is, the profit over a month from the merchant account 110 payable to the member bank 102 or other processing entity. The period calculator selects a profit-sharing interval, for example, four years or other time interval. The period profit calculator 316 applies the monthly profit 312 over the period to derive the period profit 318.

The sharing ratio engine 320 tracks the current profit sharing ratio, which in some implementations can vary according to contract, e.g., according to the merchant's behavior in meeting benchmarks or earning a higher profit sharing ratio for a given period or part of a period. The profit sharing engine 322 applies the profit sharing ratio, for example 0.25, to the period profit 318 to derive the up-front profit share 106. Then, the profit share fronting engine 324 signals or controls a transfer of the up-front profit share 106 from a given member bank 102 to the merchant bank account 328 in the corresponding merchant's bank 330. In a variation, the up-front profit share 106 can originate from the marketing entity 104, depending on individual contract. The automatic function of the profit share fronting engine 324 can also be performed manually in some implementations: i.e., the calculated up front profit share 106 can also be transferred manually, by writing a check, etc.

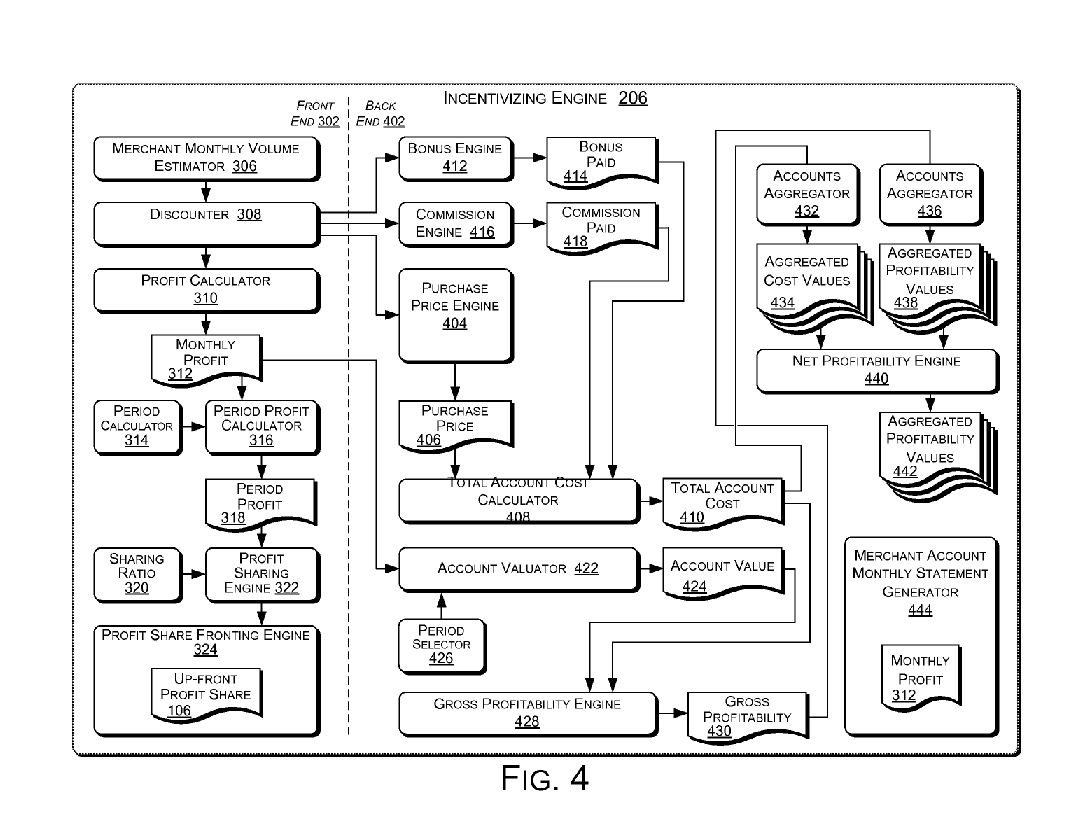

FIG. 4 shows the exemplary incentivizing engine 206 of FIG. 2, including the front end part 302 of FIG. 3, in greater detail. The front end part 302 may have the same components as shown in FIG. 3, or may have another configuration of the same or similar components.

In one implementation, the incentivizing engine 206 also includes a back end 402, which provides more sophisticated financial information and account valuation that may be presented to merchants 108, to member banks 102, or to marketing entities 104, or may be processed further into even more detailed financial or status information about the merchant account(s) 110. The incentivizing engine 206 can provide various intermediate merchant account statuses and can ultimately provide a readout of net profitability for the member bank 102 or the marketing entity 104.

The back end 402 part of the incentivizing engine 206 includes a purchase price engine 404 to derive a purchase price 406 for a given merchant account 110. The purchase price 406 arrived at may or may not be the same amount as the up-front profit share 106 arrived at by the profit sharing engine 322. The purchase price 406 thus obtained may be used in a variation of the profit sharing incentive system 200 that purchases processing rights of a merchant account 110. Or, the purchase price 406 may be used as a value internal to the incentivizing engine 206 for deriving other useful valuation quantities to be described below.

The purchase price 406 is fed to an account cost calculator 408 that determines a total account cost 410. The total account cost calculator 408 may also receive input from an optional bonus engine 412 that determines a bonus 414 to be paid to each merchant account 110, e.g., per year. The total account cost calculator 408 may also receive input from a commission engine 416 that determines a commission paid 418 per time period, such as on a yearly basis.

In parallel with the total account cost calculator 408, an account valuator 422 determines an account value 424 according to user-selected parameters. For example, a period selector 426 may allow the user to select a time period over which the account is valued. Accordingly, the account valuator 422 may accept the monthly profit 312 determined by the front end part 302 as input.

A gross profitability engine 428 determines a profitability 430 of each merchant account 110 by comparing each account value 424 with the corresponding total account cost 410.

The gross profitability 430 of each merchant account 110 can be used as input to account aggregators 432 and 436, which determine aggregated cost values 434 and aggregated profitability values 438. For example, the account aggregators 432 and 436 can determine account cost values 434 and profitability values 438 across 10 accounts, or 50, 100, 200, 500, 1000, 2500, 5000 accounts, etc., accounts. Then, a net profitability engine 440 can provide aggregated profitability values 442 for the selected number of accounts, by comparing the aggregated cost value 434 for, e.g., 2500 accounts, with the aggregated profitability value 438 for the same number of accounts.

Finally, a merchant account monthly statement generator 444 can create periodic statements suitable for electronic delivery or paper printout and mailing for each merchant account 110, including the monthly profit 312 and many other account values generated by the incentivizing engine 206.

Exemplary User Interface

FIG. 5 shows an example user interface 500 for displaying some of the merchant account values and indicators determined by the incentivizing engine 206. The user interface 500 may include one or more of the following readouts: a merchant monthly account volume readout 502 showing volume of credit card transactions; a prevailing discount rate readout 504; and a monthly profit readout 506 for a given account. The user interface 500 may further include one or more of a profit sharing period readout 508; a period profit readout 510; a profit sharing ratio readout 512; and an up-front profit share readout 514. Even further, the user interface 500 may include a bonus to be paid readout 516; a commission to be paid readout 518; an account value readout 520; a total account cost readout 522; and a profitability readout 524. Lastly, the user interface 500 may include a number of accounts to aggregate readout 526; an aggregated profitability readout 528; an aggregated cost readout 530; and a net profitability readout 532. The readouts listed above display input received from corresponding components in the exemplary incentivizing engine 206.

Exemplary Methods

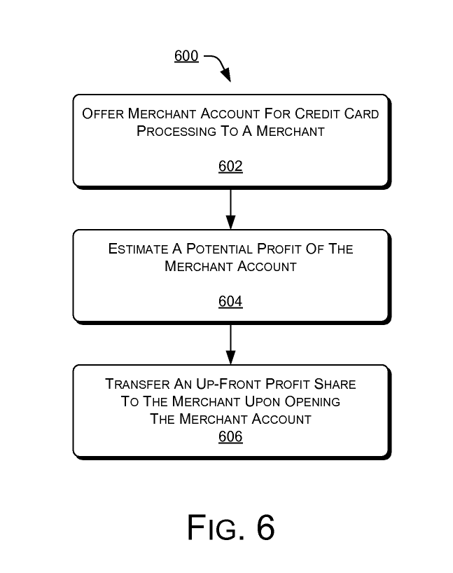

FIG. 6 shows an exemplary method 600 of transferring an up-front profit share to incentivize opening a merchant account. In the flow diagram, the operations are summarized in individual blocks. The exemplary method 600 may be performed by combinations of hardware, software, firmware, etc., for example, by components of the exemplary incentivizing engine 206.

At block 602, a merchant account for processing credit card payments is offered to a merchant. The offer may be made via online advertising, e.g., over the Internet. The offer includes an offer to pay the merchant an up-front profit share based on the known, likely, or estimated transaction volume of the merchant.

At block 604, a potential profit of the merchant account is estimated. For, example the merchant's monthly processing volume in estimated credit card transactions is determined or estimated. The profit flowing back to the member bank, marketing entity, or other processing entity due to the effective discount rate is then calculated for a month, year, or other period, such as a four year time interval.

At block 606, an up-front profit share is transferred to the merchant upon opening the merchant account. Once the merchant actually agrees to open the merchant account and the account is underwritten, then the up-front profit share incentive is paid out to the merchant, e.g., online or otherwise, and the merchant is ready to conduct business through the new merchant account.

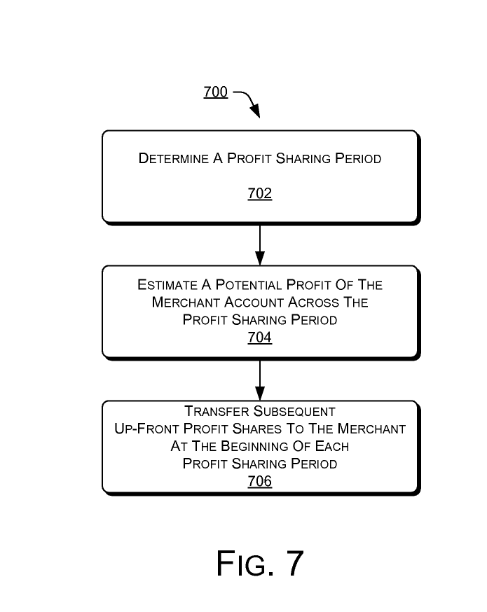

FIG. 7 shows an exemplary method 700 of transferring recurring profit-shares to incentivize maintenance of a merchant account. In the flow diagram, the operations are summarized in individual blocks. The exemplary method 700 may be performed by combinations of hardware, software, firmware, etc., for example, by components of the exemplary incentivizing engine 206.

At block 702, a profit sharing period is determined. Once a merchant has opened a merchant account and has received the up-front profit share, time passes and eventually runs the course of the profit sharing period from which the up-front profit was calculated. Before the beginning of a new profit sharing period, the potential profit of a subsequent profit sharing period can be calculated.

At block 704, a potential profit of the merchant account across the profit sharing period is estimated. That is, before the beginning of the new profit sharing period, the potential profit of this subsequent profit sharing period is calculated.

At block 706, subsequent up-front profit shares are transferred to a merchant at the beginning of each profit sharing period. That is, near or at the beginning of the new profit sharing period, a subsequent up-front profit share is offered to the merchant to maintain the merchant account and then paid to the merchant if the merchant account stays open. The amount of the up-front profit share may have changed from the first profit share that was paid on opening the account, since the transaction volume of the account (or a discount rate) may have changed in the meantime.

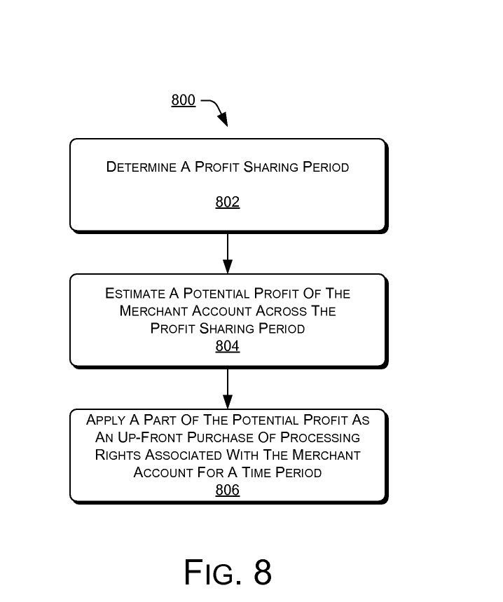

FIG. 8 shows an exemplary method 800 of applying an up-front purchase of processing rights to incentivize opening a merchant account. In the flow diagram, the operations are summarized in individual blocks. The exemplary method 800 may be performed by combinations of hardware, software, firmware, etc., for example, by components of the exemplary incentivizing engine 206.

At block 802, a profit sharing or other operational period of time is determined. The purpose of selecting a time period is to obtain an interval of time across which the profits generated for the member bank or other processing entity are great enough to make profit sharing with the merchant meaningful.

At block 804, a potential profit of the merchant account across the profit sharing period is estimated. A current monthly discount rate or other interchange fee may be applied to the monthly volume and multiplied by the number of months in the selected time interval to arrive at a potential profit for the selected period.

At block 806, a part of the potential profit is applied as an up-front purchase of processing rights associated with the merchant account for a time interval. Instead of paying the merchant a profit share, the member bank or other processing entity performs an up-front purchase of the processing rights associated with the merchant account for the operational period of time.

### CONCLUSION

Although exemplary systems and methods have been described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. A method, comprising:
offering a merchant account to a merchant, the merchant account enabling credit card processing for payment of goods and services;
estimating a potential profit associated with the merchant account; and
indicating an amount of an up-front profit share to the merchant as an incentive for opening the merchant account.

2. The method as recited in claim 1, further comprising transferring the up-front profit share to the merchant upon opening the merchant account.

3. The method as recited in claim 1, wherein the potential profit is derived by applying a discount rate to a merchant transaction volume across a time period; and
wherein the up-front profit share is determined by applying a sharing ratio to the potential profit.

4. The method as recited in claim 3, wherein the time period comprises a profit sharing period of four years, and the up-front profit share comprises one-fourth of the potential profit of the profit sharing period.

5. The method as recited in claim 1, further comprising:
determining a profit sharing period;
determining the potential profit across the profit sharing period; and
transferring subsequent up-front profit shares to the merchant at the beginning of each profit sharing period.

6. The method as recited in claim 1, wherein the up-front profit share is merchant-selectable as cash, gift cards, equipment, or purchase credits.

7. The method as recited in claim 1, further comprising:
determining an account value of the merchant account and a profitability of the merchant account; and
periodically providing the account value and the profitability to the merchant on a paper or an electronic statement.

8. The method as recited in claim 1, further comprising:
calculating an amount of the up-front profit share;
applying the amount as an up-front purchase for a time interval of servicing rights and transaction processing rights associated with the merchant account.

9. The method as recited in claim 1, further comprising:
computing parameters of the merchant account;
displaying the parameters on a user interface; and
wherein the parameters are selected from the group of parameters that includes a merchant account monthly volume, a discount rate, a monthly profit, a profit sharing period, a period profit, a sharing ratio, the up-front profit share, a bonus to be paid, a commission to be paid, an account value, a total account cost, and a profitability.

10. The method as recited in claim 9, further comprising:
computing the parameters across multiple merchant accounts;
displaying the parameters for the multiple merchant accounts on the user interface; and
wherein the parameters for the multiple merchant accounts are selected from the group of parameters that includes a number of accounts to aggregate, an aggregated profitability, an aggregated cost, and a net profitability.

11. A system, comprising:
a computing device;
an incentivizing engine associated with the computing device for estimating a potential profit associated with a merchant account, the merchant account enabling a merchant to accept credit card transactions for payment of goods and services; and
wherein the incentivizing engine indicates to the merchant via a communication an amount of an up-front profit share as an incentive for opening the merchant account.

12. The system as recited in claim 11, wherein the communication comprises an advertisement.

13. The system as recited in claim 11, wherein the incentivizing engine electronically transfers the up-front share of the potential profit to the merchant as an incentive upon opening the merchant account.

14. The system as recited in claim 11, wherein the incentivizing engine offers the merchant account and the up-front profit share to the merchant via a website on the Internet.

15. The system as recited in claim 11, wherein the incentivizing engine offers the merchant account to the merchant via Internet advertising.

16. The system as recited in claim 11, wherein the incentivizing engine:
estimates a monthly transaction volume of the merchant;
applies a discount rate to the estimated monthly transaction volume;
determines an estimated monthly profit;
calculates a period profit from the monthly profit over a profit sharing period; and
determines the up-front profit share by applying a profit sharing rate to the period profit.

17. The system as recited in claim 16, wherein the incentivizing engine derives an up-front purchase price from the period profit, wherein the purchase price values processing rights of the merchant account for a time interval.

18. The system as recited in claim 17, wherein an amount of the purchase price is equivalent to an amount of the up-front profit share.

19. The system as recited in claim 11, further comprising a profitability engine to compare a total account cost of the merchant account with an account value of the merchant account.

20. The system as recited in claim 19, further comprising account aggregators to compile aggregated cost values and aggregated profitability values across multiple merchant accounts in order to determine corresponding aggregated profitability values.

21. The system as recited in claim 11, further comprising a statement generator to communicate merchant account statuses and statistics to the merchant, including a periodic profit of an entity processing credit card transactions for the merchant account.

22. A system, comprising:
a computing device;
a profit sharing engine for estimating a potential profit associated with a merchant account, the merchant account enabling a merchant to accept credit card transactions for payment of goods and services; and
a user interface for displaying an up-front profit share of the potential profit to the merchant as an incentive for opening the merchant account.

23. The system as recited in claim 22, further comprising an incentivizing engine to estimate values associated with the merchant account;
wherein the user interface displays the values;
and wherein the values include one or more of a merchant periodic transaction volume, a discount rate, a monthly profit, a profit sharing period, a period profit, a bonus to be paid, a commission to be paid, a purchase price for buying processing rights of the merchant account for a time interval, a total account cost, a total account value, a profitability of the merchant account, aggregated cost values over multiple merchant accounts, aggregated profitability values over multiple merchant accounts, aggregated profitability values, and at least part of a monthly account statement.

24. A method, comprising:
marketing merchant accounts for enabling merchants to use credit card transactions for receiving payments;
estimating an up-front profit share for individual potential merchant accounts; and
transferring an indication of the up-front profit share to each merchant associated with a corresponding potential merchant account as an incentive for opening the merchant account.

25. The method as recited in claim 24, further comprising transferring the up-front profit share to an individual merchant upon opening the corresponding merchant account.

26. A system, comprising:
means for estimating a potential profit associated with a potential merchant account, wherein an opened merchant account enables a merchant to accept credit card transactions for payment of goods and services; and
means for indicating to the merchant an up-front profit share associated with the merchant account as an incentive for opening the merchant account.

27. The system as recited in claim 26, further including means for automatically transferring the up-front profit share to the merchant upon opening the merchant account.
